(19) United States
(12) Patent Application Publication
(10) Pub. No.: US 2011/0170674 A1
(43) Pub. Date: Jul. 14, 2011

(54) APPARATUS, A MEDIATING METHOD, A PROGRAM THEREOF AND A SYSTEM

(75) Inventor: Kenichi EGAMI, Tokyo (JP)

(73) Assignee: NEC CORPORATION, Tokyo (JP)

(21) Appl. No.: 12/976,718

(22) Filed: Dec. 22, 2010

(30) Foreign Application Priority Data
Jan. 13, 2010 (JP) 2010-004753

(51) Int. Cl. H04M 11/00; G10L 15/26

(52) U.S. Cl. 379/88.14; 704/235; 704/E15.043

(57) ABSTRACT

An apparatus and method automatically substitutes personal information in a message with a character string that does not include the personal information. The personal information is stored in a substitution table with relation to the character string. In a response message, sent in response to the message, the character string is automatically substituted with the corresponding personal information stored in the substitution table.

This application is based upon and claims the benefit of priority from Japanese patent application No. 2010-004753, filed on Jan. 13, 2010, the disclosure of which is incorporated herein in its entirety by reference.

### BACKGROUND

The present invention relates to an apparatus, a mediating method, a program thereof and a system. More particularly, it relates to an apparatus, a mediating method, a program and a system for mediating a message which includes personal information without causing a problem that the personal information is leaked.

As a technology for preventing leakage of the personal information, various server devices are known which mediate a message from a source terminal to a receiving terminal. Japanese Patent Laid-Open No. 2002-245043 (hereinafter, called as Patent 1) and Japanese Patent Laid-Open No. 2006-221560 (hereinafter, called as Patent 2) disclose examples of these kind of server devices as described below.

Patent 1 discloses an electrical transaction system where a user can get product information in detail without giving personal information to a seller. In Patent 1, after the seller sends a negotiation request for getting the personal information to the user via the server device and the user agrees to the seller's request, the server device cancels keeping the user's personal information secret. After that, it is possible for the seller to get user's personal information from the user and start the negotiation.

Patent 2 discloses a server device which extracts personal information by syntactic analysis of document data, substitutes other information which does not include the personal information for the extracted personal information and outputs the other information. In Patent 2, a substitution rule of each category of the personal information is predetermined. The extracted personal information which is over a predetermined confidence value of the personal information is substituted with the other information based on the substitution rule. In Patent 2, as the other information, “Person Name”, “EMAIL” etc. are used.

For example, in the situation where a server device uses personal information, the timing of dealing with an inquiry from a user is considered. This is because this kind of inquiry usually includes personal information. The developer side of various products responds to inquiries from users. Generally, the user makes an inquiry when it is impossible for the user to solve a problem by themselves and they want to improve the difficult situation.

When the personal information is leaked in this situation, the leakage of the personal information is more serious for the user than a problem in the inquiry. Therefore, the developer side has to consider various measures for preventing leakage of the personal information. However, as a result of executing these various measures, it is possibility that various measures may lose the convenience for communication between the user and a person in charge of a case in the developer side. Furthermore, the user can not get a reasonable solution from the developer side.

For example, as disclosed in Patent 2, a server device extracts personal information by syntactic analysis of document data, substitutes other information which does not include the personal information for the extracted personal information and outputs the other information. However, if this kind of technology is used in the case that a server device deals with a user's inquiry, a reply to user's inquiry does not include the personal information in addition to user's inquiry. As a result, a problem is caused in which the user has to read the reply from the developer side while guessing the substituted part in the user's inquiry. Also, a further inconvenience is caused in which the user has to respond to the reply where the personal information is substituted.

As described above, in related technologies, the substitution of the personal information in a user's inquiry causes a loss in smoothness of communication, which leads to the incapability of ensuring both confidentiality and convenience.

An object of certain embodiments of the present invention is to provide an apparatus, a mediating method, a program and a system capable of ensuring both convenience and confidentiality.

### SUMMARY OF THE INVENTION

A non-limiting feature of certain embodiments of the invention provides an apparatus capable of automatically substituting personal information in a message with a character string which does not include the personal information and automatically substituting the substituted character string in a response message to the message with the corresponding personal information based on a substitution table. The substitution table stores the personal information with relation to the character string.

According to another feature of the invention, there is provided a method for automatically substituting personal information in a message with a character string which does not include the personal information and automatically substituting the substituted character string in a response message to the message with the corresponding personal information based on a substitution table. The substitution table stores the personal information with relation to the character string.

According to another feature of the invention, there is provided a program for, automatically substituting personal information in a message with a character string which does not include the personal information and automatically substituting the substituted character string in a response message to the message with the corresponding personal information based on a substitution table. The substitution table stores the personal information with relation to the character string.

According to another feature of the invention, there is provided a system capable of automatically substituting personal information in a message with a character string which does not include the personal information and automatically substituting the substituted character string in a response message to the message with the corresponding personal information based on a substitution table. The substitution table stores the personal information with relation to the character string.

### BRIEF DESCRIPTION OF THE DRAWING

Other feature and advantages of various embodiments of the present invention will become apparent by the following detailed description and the accompanying drawings, wherein:

FIG. 1 is a block diagram indicating a configuration of an information processing system in a first exemplary embodiment of the present invention.

FIG. 2 is a block diagram indicating the configuration of the information processing system.

FIG. 3 is a flow chart indicating the operating procedures of a first server when the first server receives an inquiry.

FIG. 4 is a flow chart indicating the operating procedures of the first server when the first server receives a response to an inquiry.

FIG. 5 is a block diagram indicating a configuration of an information processing system in a second exemplary embodiment in the present invention.

FIG. 6 is an example of an email where “Privacy Data” is inserted.

FIG. 7 is an example of the inquiry form.

### DETAILED DESCRIPTION

A first exemplary embodiment of the present invention will be described in detail below with reference to the drawings. Note that the present invention is not limited to this exemplary embodiment.

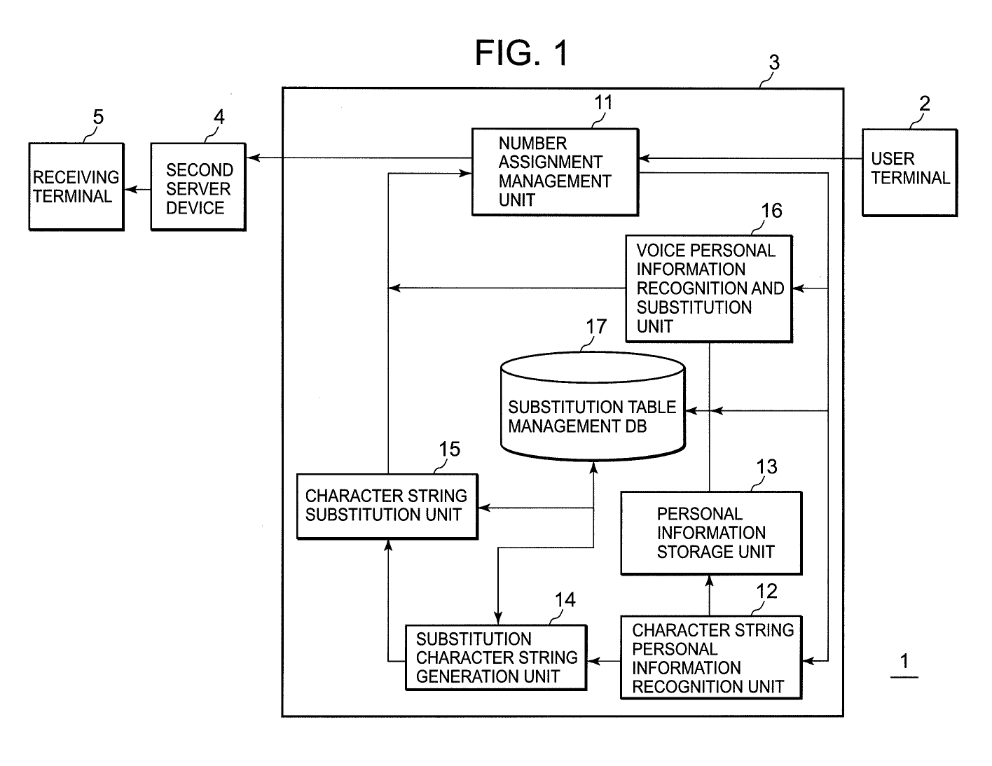

FIG. 1 shows an example of a configuration of an information processing system 1. The information processing system 1 has a sending terminal such as a user terminal 2, a first server device 3 as a message mediation apparatus, a second server device 4, and a receiving terminal 5. The sending terminal is a source terminal. The receiving terminal 5 is a terminal of person in charge of a case whose inquiry which a user of the user terminal 2 sends. Each arrow in FIG. 1 indicates a flow of information from the user terminal 2 to receiving terminal 5.

The first server device 3 functionally has at least a number assignment management unit 11, a character string personal information recognition unit 12 as an identification unit, a personal information storage unit 13 as a storage control unit, a substitution character string generation unit 14 as the storage control unit, a character string substitution unit 15 as a substitution unit, a voice personal information recognition and substitution unit 16, and a substitution table management DB (database) 17 as a storage unit.

Note that the first server device 3 according to this embodiment includes the same pieces of hardware (not shown) as those of general computer equipment, such as a CPU (Central Processing Unit), a ROM (Read Only Memory) connected to the CPU by a bus, a RAM (Random Access Memory), a memory unit, an input unit, a display unit, and an I/O interface. The memory unit is, for example, an external memory device such as an HDD (Hard Disk Drive). The first server device 3 according to this embodiment may be physically a dedicated system or a general-purpose information processing apparatus. For example, in an information processing apparatus with a general configuration, each process in the first server device 3 according to this embodiment can also be realized by starting specified software.

For example, the number assignment management unit 11, the character string personal information recognition unit 12, the personal information storage unit 13, the substitution character string generation unit 14, the character string substitution unit 15, and the voice personal information recognition and substitution unit 16 can be mainly realized by the CPU executing programs stored in the ROM and RAM and controlling the pieces of hardware. The substitution table management DB 17 can store a personal information substitution table (to be described later) as a substitution table by using the memory unit.

The user terminal 2 is a personal computer or the like. For example, the user terminal 2 accesses the first server device 3 over the Internet or the like and displays a predetermined user inquiry screen on its display unit. The user terminal 2 transmits an inquiry (message) prepared by a user's making entries in the user inquiry screen displayed on its display unit to the first server device 3 over the Internet or the like. The user terminal 2 prompts a user to enter arbitrary character strings in a part where the personal information is described.

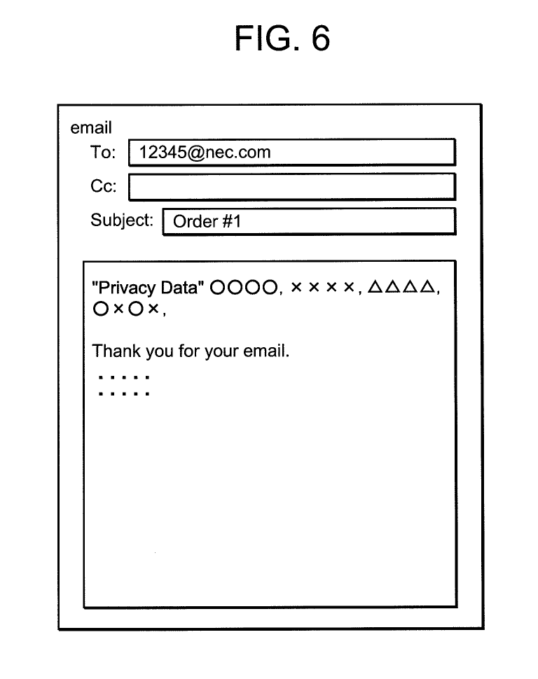

For example, as described in FIG. 6, the arbitrary character strings “Privacy Data” is inserted before the personal information which a user of the user terminal 2 recognizes. In the case that there is lots of the personal information, they are separated by commas etc. In this case, the personal information is described in the first line of an email. In FIG. 6, “◯◯◯◯”, “xxxx”, “ΔΔΔΔ” and “◯x ◯x” which follows “Privacy Data” are personal information. As the above-described, the user can determine what is information to be recognized as the personal information.

Also, in addition to the inserted arbitrary character strings, the personal information is recognized based on a condition determined in advance. The condition is explained later.

The number assignment management unit 11 assigns an inquiry number to each of inquires received from the user terminal 2. The number assignment management unit 11 includes an assigned inquiry number in the subject field of an inquiry and manages inquiries by inquiry number. The number assignment management unit 11 manages inquiry communications on a single matter by using a single inquiry number. For example, the single inquiry mumber is included in “an inquiry”, “a first response message” such as a response to the inquiry, “a second response message” such as a response to the first response message and “a third response message” such as a response to the second response message. Later, a management based on the single number is described in detail. The number assignment management unit 11 transmits an inquiry with an assigned number to the character string personal information recognition unit 12.

The number assignment management unit 11 creates one personal information substitution table for each inquiry number. The personal information substitution table is a table for substituting a piece of personal information in an inquiry with a substitution character string which does not include the personal information and for substituting the substitution character string in the response to the inquiry (the first response message) with the corresponding piece of personal information. The substituting the substitution character string in the first response message with the corresponding piece of personal information means that the substitution character string is changed back to the corresponding piece of personal information. The number assignment management unit 11 writes a created personal information substitution table to the substitution table management DB 17.

The character string personal information recognition unit 12 identifies pieces of personal information corresponding to the personal information items set in advance according to a convention and categorizes the identified pieces of personal information based on the convention. For example, the category includes name, e-mail address, IP address, and telephone number. The character string personal information recognition unit 12 recognizes information including “@” as an email address and classifies it into a category of the email address. Also, the character string personal information recognition unit 12 recognizes information having a format such as “192.168.0.1” as IP address and classifies it into a category of IP address. Generally, the format of IP address is “number from 0 to 255”+“.”+“number from 0 to 255”+“.”+“number from 0 to 255”+“.”+“number from 0 to 255”. Also the character string personal information recognition unit 12 recognizes information having a predetermined number of consecutive numbers as telephone number and classifies it into a category of telephone number. The telephone number might include “-” or “( )”.

The character string personal information recognition unit 12 identifies pieces of information following “Privacy Data” on the first line of the body of an email message and categorizes the identified information. The character string personal information recognition unit 12 transmits the personal information and category information to the personal information storage unit 13.

The character string personal information recognition unit 12 also transmits an inquiry received from the number assignment management unit 11 to the substitution character string generation unit 14.

The personal information storage unit 13 stores pieces of personal information identified by the character string personal information recognition unit 12 and category information in a personal information substitution table for a corresponding inquiry number of the substitution table management DB 17.

The substitution character string generation unit 14 reads out a personal information substitution table corresponding to the inquiry number of an inquiry received from the character string personal information recognition unit 12 from the substitution table management DB 17. The substitution character string generation unit 14 generates, for each piece of personal information in the personal information substitution table, a substitution character string for substituting the piece of personal information with a character string without the piece of personal information.

For example, the substitution character string generation unit 14 generates a substitution character string as a combination of a piece of category information stored in association with a piece of personal information and a number. If there is the same substitution character string as a substitution character string created by the substitution character string generation unit 14, a new substitution character string whose number is added by ‘1’ is created. For example, the created substitution character string are “Name 1”, “Name 2”, “Address 1”, “Address 2”, “telephone number 1” and “telephone number 2”.

The substitution character string generation unit 14 stores the generated substitution character string in the personal information substitution table in association with a piece of personal information. And the substitution character string generation unit 14 stores the personal information substitution table in the substitution table management DB 17. The substitution character string generation unit 14 transmits an inquiry received from the character string personal information recognition unit 12 to the character string substitution unit 15. Note that a method for crating the substitution character string is not limited to this embodiment. For example, various methods for crating the substitution character string are considered by editing files for set up.

The character string substitution unit 15 reads out a personal information substitution table corresponding to the inquiry number of an inquiry received from the substitution character string generation unit 14 from the substitution table management DB 17. The character string substitution unit 15 refers to the read-out personal information substitution table and substitutes each piece of personal information in the text of the inquiry with a corresponding substitute character string. The character string substitution unit 15 transmits the inquiry where the personal information is substituted (hereinafter referred to as a “substituted inquiry”) to the second server device 4 through the number assignment management unit 11. The second server device 4 is made of a mail server and a file transfer server as known generally and servers which perform IP telephony, web conferencing, and the like.

The second server device 4 performs predetermined processing including archiving, virus scanning, and filtering on a substituted inquiry received from the first server device 3. Then the second server device 4 transmits the substituted inquiry to the receiving terminal 5.

The receiving terminal 5 is a personal computer or the like. For example, the receiving terminal 5 transmits a response to the substituted inquiry as the first response message to the second server device 4. It is okay that the first response message is called as “a substituted inquiry response”. Note that if the first response message is prepared by a reply function, the same inquiry number as the inquiry's inquiry number is included in the subject field of the first response message.

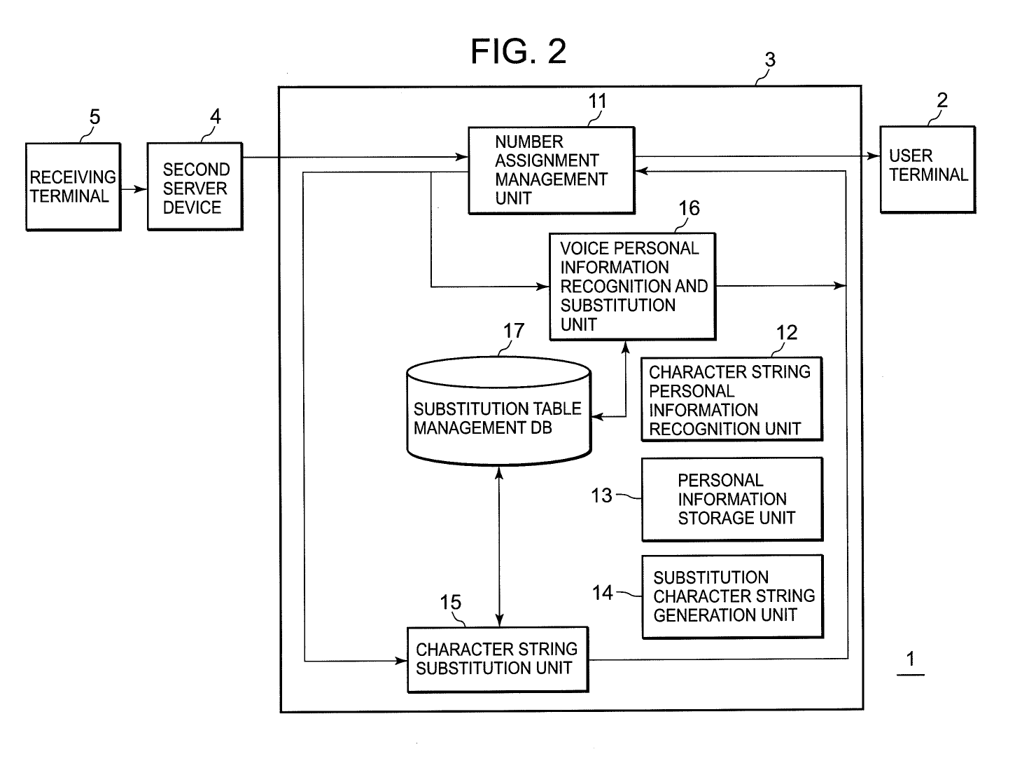

FIG. 2 shows the information processing system 1 including flows of information from the receiving terminal 5 to the user terminal 2 by arrows.

In this case, the second server device 4 performs predetermined processing including archiving, virus scanning, and filtering on a substituted inquiry response received from the receiving terminal 5. Then the second server device 4 transmits the first response message to the first server device 3.

The number assignment management unit 11 transmits the first response message received from the second server device 4 to the character string substitution unit 15. The character string substitution unit 15 reads out a personal information substitution table corresponding to the inquiry number of the first response message from the substitution table management DB 17. The character string substitution unit 15 refers to the personal information substitution table and substitutes each substitution character string in the first response message with a corresponding piece of personal information. Then the character string substitution unit 15 transmits the substituted first response message to the user terminal 2 through the number assignment management unit 11.

For example, the user terminal 2 displays a predetermined user inquiry response screen containing the first response message on its display unit. If the user desires to make a further inquiry about the substituted first response message such as the second response message, the user terminal 2 transmits the second response message to the first server device 3 over the Internet or the like. Note that if the second response message is prepared by a reply function, the same inquiry number as the first response message is included in the subject field of the second response message.

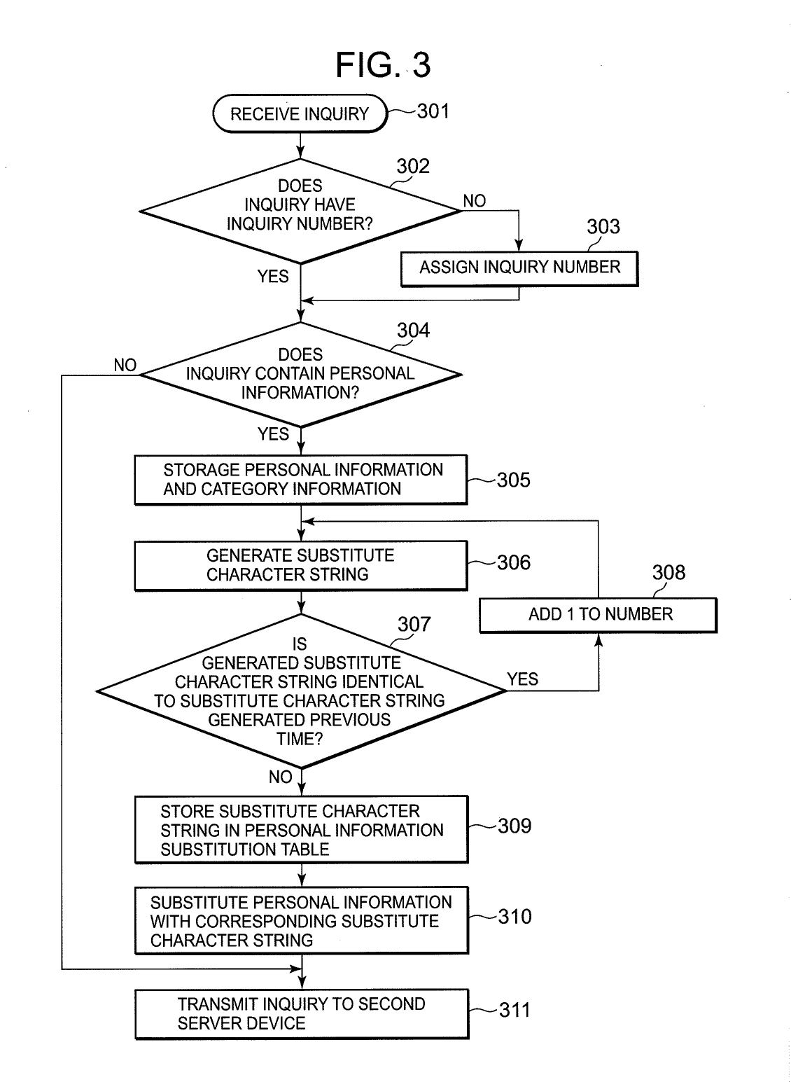

FIG. 3 is a flowchart indicating an operation of the first server device 3 upon receipt of an inquiry from the user terminal 2.

When the number assignment management unit 11 receives an inquiry from the user terminal 2 (301), it checks whether the inquiry has an already assigned inquiry number or not (302). If the inquiry does not have an assigned inquiry number (NO in 302), the number assignment management unit 11 issues a new inquiry number, assigns the number to the inquiry, and transmits the inquiry to the character string personal information recognition unit 12 (303). Also, the number assignment management unit 11 creates a personal information substitution table and stores the personal information substitution table to the substitution table management DB 17. On the other hand, if the inquiry already has an inquiry number (YES in 302), the number assignment management unit 11 transmits the received inquiry to the character string personal information recognition unit 12.

The character string personal information recognition unit 12 checks whether personal information is included in the inquiry transmitted from the number assignment management unit 11 (304). If the inquiry does not contain personal information (NO in 304), the character string personal information recognition unit 12 transmits the inquiry to the second server device 4 through the substitution character string generation unit 14, the character string substitution unit 15, and the number assignment management unit 11 without processing (311). On the other hand, if the inquiry contains personal information (YES in 304), the character string personal information recognition unit 12 transmits the personal information and category information to the personal information storage unit 13 and transmits the inquiry to the substitution character string generation unit 14.

The personal information storage unit 13 stores each piece of personal information in the inquiry transmitted from the character string personal information recognition unit 12 and a corresponding piece of category information in the personal information substitution table corresponding to the inquiry number (305).

The substitution character string generation unit 14 reads out the personal information substitution table corresponding to the inquiry number of the inquiry transmitted from the character string personal information recognition unit 12 and generates a substitute character string for each category (306). More specifically, the substitution character string generation unit 14 generates the substitute character string as a combination of apiece of category information and a number.

The substitution character string generation unit 14 checks whether the generated substitute character string is identical to a substitute character string generated a previous time (307). If the generated substitute character string is identical to a substitute character string generated a previous time (YES in 307), the substitution character string generation unit 14 adds ‘1’ to the number of the substitute character string generated this time (308) and generates a substitute character string again (306). When generation of all substitute character strings is completed, the substitution character string generation unit 14 stores each generated substitute character string in the personal information substitution table in association with a corresponding piece of personal information (309) and stores the personal information substitution table to the substitution table management DB 17. The substitution character string generation unit 14 then transmits the inquiry to the character string substitution unit 15.

The character string substitution unit 15 reads out and refers to the personal information substitution table corresponding to the inquiry number of the inquiry and substitutes each piece of personal information in the inquiry transmitted from the substitution character string generation unit 14 with a corresponding one of the substituted character strings (310). The character string substitution unit 15 then transmits the inquiry to the second server device 4 through the number assignment management unit 11 (311).

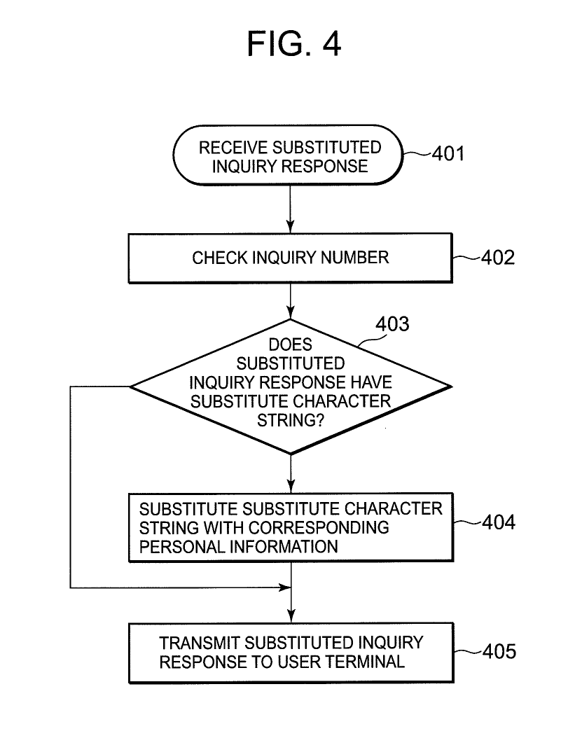

FIG. 4 is a flowchart indicating an operation of the first server device 3 upon receipt of a first response message from the second server device 4.

When the number assignment management unit 11 receives the first response message from the second server device 4 (401), it transmits the first response message to the character string substitution unit 15.

The character string substitution unit 15 checks the inquiry number of the first response message (402). The character string substitution unit 15 reads out and refers to a personal information substitution table corresponding to the inquiry number and checks whether the first response message contains a substitute character string or not (403). If the first response message does not contain a substitute character string (NO in 403), the character string personal information recognition unit 12 transmits the first response message to the user terminal 2 through the number assignment management unit 11 without processing (405).

On the other hand, if the first response message contains a substitute character string (YES in 403), the character string substitution unit 15 reads out and refers to the personal information substitution table corresponding to the inquiry number of the first response message and substitutes each substitute character string in the first response message with a corresponding piece of personal information (404).

The character string substitution unit 15 transmits the substituted first response to the user terminal 2 through the number assignment management unit 11 (405).

As described above, in this exemplary embodiment, the first server device 3 stores a personal information substitution table containing pieces of personal information, substitute character strings, and the like in the substitution table management DB 17. And the first server device 3 reads out and refers to the personal information substitution table. As a result, it is possible to automatically substitute an inquiry containing personal information which is transmitted from the user with a character string which does not include the personal information. Additionally, the first server device 3 recognizes an arbitrary character string specified by the user as a piece of personal information and substitutes the character string with a substitute character string. The person in charge of the case prepares a response to an substituted inquiry such as a first response message and sends the first response message to the inquiry.

At this time, the first server device 3 automatically substitutes each substitute character string in the first response message with a corresponding one of original pieces of personal information and transmits it to the user terminal 2. The first server device 3 automatically makes and updates a personal information substitution table during executing a processing.

In this exemplary embodiment, it is possible for a person in charge of the case to make a response to an inquiry without taking care of personal information in the inquiry. Since personal information is not contained in the inquiry which the person in charge of the case receives, even if information of the inquiry leaks out by some accident, the first server device 3 can prevent leakage of the personal information.

The first server device 3 automatically performs dynamic substitution for each of two directions, a direction from the user toward the person in charge of the case and a direction from the person in charge of the case toward the user. Since the user can prepare an inquiry containing personal information and refer to a response containing the personal information, and the person in charge of the case can prepare a response with information where personal information is substituted, the convenience for communication is not lost. In this exemplary embodiment, a single table is used for each inquiry number on sending and receiving email, file transfer, and the like, thereby further improving the convenience for communication.

Therefore, a system capable of ensuring both protection of personal information and smooth communication can be realized.

Note that the voice personal information recognition and substitution unit 16 is used for IP telephony, web conferencing, and the like. The voice personal information recognition and substitution unit 16 performs the same processing as the character string personal information recognition unit 12, personal information storage unit 13, substitution character string generation unit 14, and character string substitution unit 15 except that an inquiry with text is replaced with an inquiry with a voice.

More specifically, the voice personal information recognition and substitution unit 16 transforms voice data in an inquiry into text data, identifies personal information in the transferred inquiry in the same manner as the above-described manner, substitutes the personal information with a substitute character string, transforms text data of the substituted inquiry into voice data and sent it to the receiving terminal 5.

Also, the voice personal information recognition and substitution unit 16 transforms voice data in an first response data from receiving terminal 5 into text data, identifies a substituted part in the first response message, substitute it with the personal information based on a personal information substitution table, transforms text data of the substituted first response message into voice data and send it to the user terminal 2.

Note that the voice personal information recognition and substitution unit 16 receives voice data from the user terminal 2 and the receiving terminal 5 through the number assignment management unit 11. Also, the voice personal information recognition and substitution unit 16 sends voice data to the user terminal 2 and the receiving terminal 5 through the number assignment management unit 11.

Incidentally, the voice personal information recognition and substitution unit 16 might have only a transformation function between voice data and text data. In this case, another units in the information processing system 1 has the same function as the above-described one.

Also, a voice recognition method is not limited to this exemplary embodiment. Various method can be used.

Incidentally, information other than “Privacy Data” might be used on the first line of the body of an email as information for determining whether it is personal information or not. Various other methods may be used.

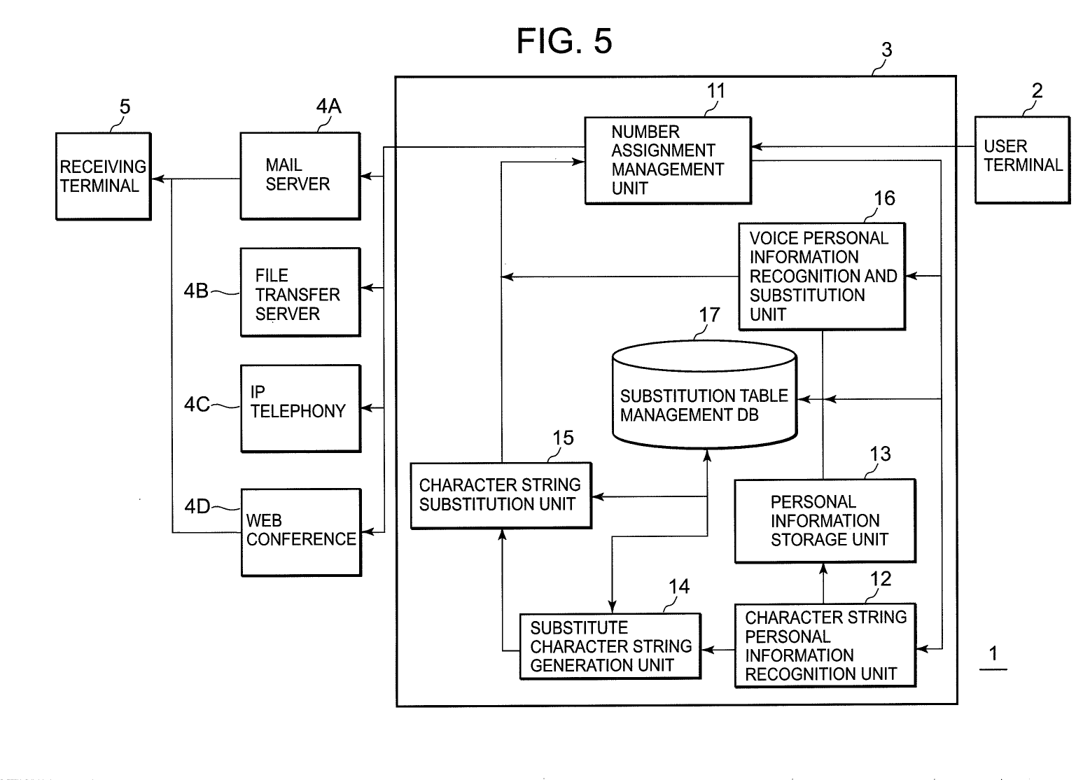

FIG. 5 is another example of the present invention. FIG. 5 shows an example of a configuration of an information processing system 1 when an inquiry about a question on a product or the trouble with the product etc is transmitted.

To identify the cause of the trouble with a product, pieces of personal information such as a user environment, a log file, a user ID, and an IP address of a user are required. In this case, a first server device 3 stores the pieces of personal information in a substitution table management DB 17, i.e., stores the pieces of personal information outside the control of a person in charge of the case. This can prevent leakage of the pieces of personal information.

The first server device 3 automatically performs bidirectional substitution, which allows the user to transmit and receive data including personal information and which allows the person in charge of the case to transmit and receive data which does not include personal information. That is, the first server device 3 can automatically perform substitution without making both of the user and the person in charge of the case conscious of substitution of information.

As shown in FIG. 5, the first server device 3 is capable of linking various server devices such as a mail server 4A, a file transfer server 4B, an IP telephony server 4C, and a web conference server 4D. Substitution processing using the same personal information substitution tables is performed on pieces of information handled by the server devices (e.g., an email message, a log file, and voices of a web conference and IP telephony) by a predetermined method such as conversion of a voice into a character string. Accordingly, even if different communication means is used, smooth communication can be implemented between a user and a person in charge of a case on a case-by-case basis.

Incidentally, if a transformation function of voice/text data is not necessary, information processing system 1 might not include the voice personal information recognition and substitution unit 16.

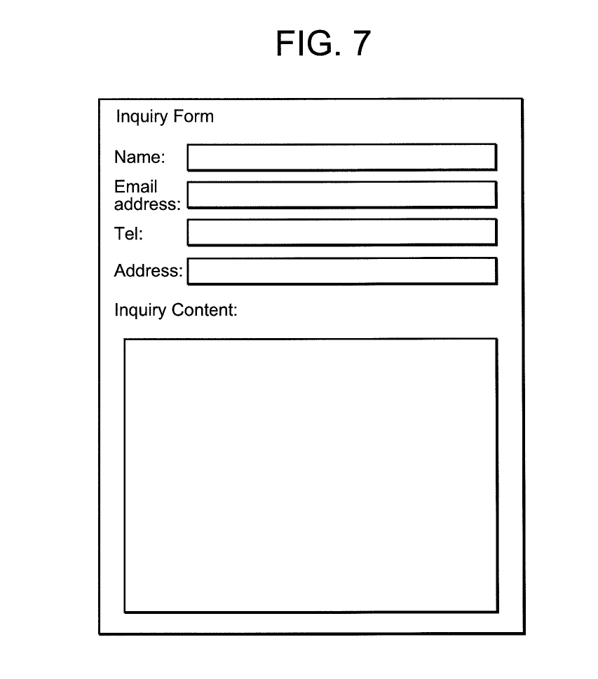

Also, the user of the user terminal 2 might make an inquiry by using a predetermined inquiry form. FIG. 7 is an example of the inquiry form. In this case, the character string personal information recognition unit 12 automatically identifies information in a field of “Name” as personal information and classifies it into a category of name. Also, the character string personal information recognition unit 12 identifies information in a field of “Email address” as personal information and classifies it into a category of email address. Also, the character string personal information recognition unit 12 identifies information in a field of “Tel” as personal information and classifies it into a category of telephone number. Also, the character string personal information recognition unit 12 identifies information in a field of “Address” as personal information and classifies it into a category of address.

Therefore, the character string personal information recognition unit 12 can determine whether it is personal information or not and what category the personal information belong to based on a location where information is input. That is to say, the character string personal information recognition unit 12 identifies information which is input in a predefined location of an input form as the personal information.

What is claimed is:

1. An apparatus comprising:
a storage unit; and
a processing unit configured to identify personal information in a message, substitute the identified personal information with a character string which does not include the personal information and store the personal information and the character string in a substitution table of the storage unit,
wherein the substitution table stores the personal information with relation to the character string, and
wherein the processing unit receives a response message responding to the message, and substitutes the personal information for the character string in the response message according to the substitution table.

2. The apparatus according to claim 1,
wherein the message is transmitted from a sending terminal to a receiving terminal and the processing unit is configured to identify the message; and
wherein the processing unit is configured to identify the personal information for the response message transmitted from the receiving terminal to the sending terminal according to the substitution table.

3. The apparatus according to claim 1, further comprising:
a message number assignment unit configured to assign a message number to the message.

4. The apparatus according to claim 3,
wherein the response message includes the message number assigned to the message.

5. The apparatus according to claim 4,
wherein the response message is a first response message and the processing unit is configured to manage the message, the first response message, a second response message sent in response to the first response message and a third response message sent in response to the second response message by using the same message number.

6. The apparatus according to claim 1,
wherein the personal information in the message includes information conforming to a convention, and
wherein the processing unit is configured to identify the information according to the convention.

7. The apparatus according to claim 6,
wherein the personal information is at least one of email address, IP address, telephone number and information marked by a predetermined character.

8. The apparatus according to claim 1,
wherein a processing unit is configured to identify information which is input in a predefined location of an input form as the personal information.

9. The apparatus according to claim 1,
wherein the character string includes information indicating a category of the personal information.

10. The apparatus according to claim 9,
wherein the character string includes the information indicating the category of the personal information and a number.

11. The apparatus according to claim 1, further comprising:
a transformation unit configured to transform voice data in the message into text data, identify personal information in the text data, substitute the identified personal information with a character string which does not contain the personal information, store the personal information and the character string in the substitution table of the storage unit and transform the substituted text data into voice data.

12. The apparatus according to claim 11,
wherein the transformation unit is configured to transform voice data in the response message into text data, substitute the personal information for the character string in the text message according to the substitution table, transform the substituted text data into voice data.

13. A mediating method comprising:
identifying personal information in a message;
performing a first substitution which substitutes the identified personal information with a character string which does not include the personal information; and
storing the personal information and the character string in a substitution table of a storage unit, and
performing a second substitution which substitutes the character string in a response message sent in response to the message with the personal information according to the substitution table,
wherein the substitution table stores the personal information with relation to the character string.

14. The mediating method according to claim 13,
wherein in the first substitution step the message is a message transmitted from a sending terminal to a receiving terminal; and
wherein in the second substitution step the response message is a response message transmitted from the receiving terminal to the sending terminal.

15. The Mediating method according to claim 13, further comprising:
assigning a message number to the message.

16. The mediating method according to claim 15,
wherein the response message includes the message number assigned to the message.

17. The mediating method according to claim 16,
wherein the response message is a first response message and the same message number is assigned to the message, the first response message, a second response message sent in response to the first response message and a third response message sent in response to the second response message in the assigning step.

18. The mediating method according to 13,
wherein the personal information in the message includes information conforming to a convention, and
wherein the information is identified according to the convention in the identifying step.

19. The mediating method according to 18,
wherein the personal information is at least one of email address, IP address, telephone number and information marked by a predetermined character in the identifying step.

20. The mediating method according to 13,
wherein information which is input in a predefined location of an input form is identified as the personal information in the identifying step.

21. The mediating method according to 13,
wherein the character string which includes information indicating a category of the personal information is stored in the storing step.

22. The mediating method according to 21,
wherein the character string which includes the information indicating the category of the personal information and a number is stored in the storing step.

23. The mediating method according to claim 13, further comprising:
performing a first transformation which transforms voice data in the message into text data;
identifying personal information in the text data;
substituting the identified personal information with a character string which does not contain the personal information;
storing the personal information and the character string in the substitution table of the storage unit; and
performing a second transformation which transforms the substituted text data into voice data.

24. The mediating method according to claim 23, further comprising:
performing a third transformation which transforms voice data in the response message into text data;
substituting the personal information for the character string in the text message according to the substitution table; and
performing a fourth transformation which transforms the substituted text data into voice data.

25. A computer readable medium having recorded thereon a program for enabling a computer to carry out a method comprising:
identifying personal information in a message;
performing a first substitution which substitutes the identified personal information with a character string which does not include the personal information; and
storing the personal information and the character string in a substitution table of a storage unit, and
performing a second substitution which substitutes the character string in a response message sent in response to the message with the personal information according to the substitution table,
wherein the substitution table stores the personal information with relation to the character string.

26. The computer readable medium having recorded thereon a program according to claim 25,
wherein in the first substitution step the message is a message transmitted from a sending terminal to a receiving terminal; and
wherein in the second substitution step the first response message is a response message transmitted from the receiving terminal to the sending terminal.

27. The computer readable medium having recorded thereon a program according to claim 25, the program enabling the computer to perform the method further comprising:
assigning a message number to the message.

28. The computer readable medium having recorded thereon a program according to claim 27,
wherein the response message includes the message number assigned to the message.

29. The computer readable medium having recorded thereon a program according to claim 28,
wherein the response message is a first response message and the same message number is assigned to the message, the first response message, a second response message sent in response to the first response message and a third response message sent in response to the second response message in the assigning step.

30. The computer readable medium having recorded thereon a program according to claim 25,
wherein the personal information in the message includes information conforming to a convention, and
wherein the information is identified according to the convention in the identifying step.

31. The computer readable medium having recorded thereon a program according to claim 30,
wherein the personal information is at least one of email address, IP address, telephone number and information marked by a predetermined character in the identifying step.

32. The computer readable medium having recorded thereon a program according to claim 25,
wherein information which is input in a predefined location of an input form is identified as the personal information in the identifying step.

33. The computer readable medium having recorded thereon a program according to claim 25,
wherein the character string which includes information indicating a category of the personal information is stored in the storing step.

34. The computer readable medium having recorded thereon a program according to claim 33,
wherein the character string which includes the information indicating the category of the personal information and a number is stored in the storing step.

35. The computer readable medium having recorded thereon a program according to claim 25, the program enabling the computer to perform the method further comprising:
performing a first transformation which transforms voice data in the message into text data;
identifying personal information in the text data;
substituting the identified personal information with a character string which does not contain the personal information;
storing the personal information and the character string in the substitution table of the storage unit; and
performing a second transformation which transforms the substituted text data into voice data.

36. The computer readable medium having recorded thereon a program according to claim 35, the program enabling the computer to perform the method further comprising:
performing a third transformation which transforms a voice data in the response message into a text data;
substituting the personal information for the character string in the text message according to the substitution table; and
performing a forth transformation which transforms the substituted text data into a voice data.

37. A system comprising:
a server configured to comprise a processing unit and a storage unit,
a sending terminal; and
a receiving terminal configured to receive a message from the sending terminal via the server and send a response message, in response to receiving the message, to the sending terminal via the server,
wherein the processing unit is configured to identify personal information in the message, substitute the identified personal information with a character string which does not include the personal information and store the personal information and the character string in a substitution table of the storage unit,
wherein the substitution table stores the personal information with relation to the character string, and
wherein the processing unit receives the response message responding to the message, and substitutes the personal information for the character string in the response message according to the substitution table.
